(19) United States
(12) Patent Application Publication
(10) Pub. No.: US 2011/0198957 A1
(43) Pub. Date: Aug. 18, 2011

(54) Jafstar system

(76) Inventor: James Albert Fair, Westchester, IL (US)

(21) Appl. No.: 12/800,362

(22) Filed: Jun. 11, 2003

(51) Int. Cl. H02K 47/00; H02K 53/00

(52) U.S. Cl. 310/113; 74/DIG. 9

(57) ABSTRACT

The JAFSTAR SYSTEM is an unique electrical generator unlike any other electrical generator today. The JAFSTAR SYSTEM is an electrical generator that runs on electricity, it's own electricity, (electricity it produces itself), with out any help from any out-side source.

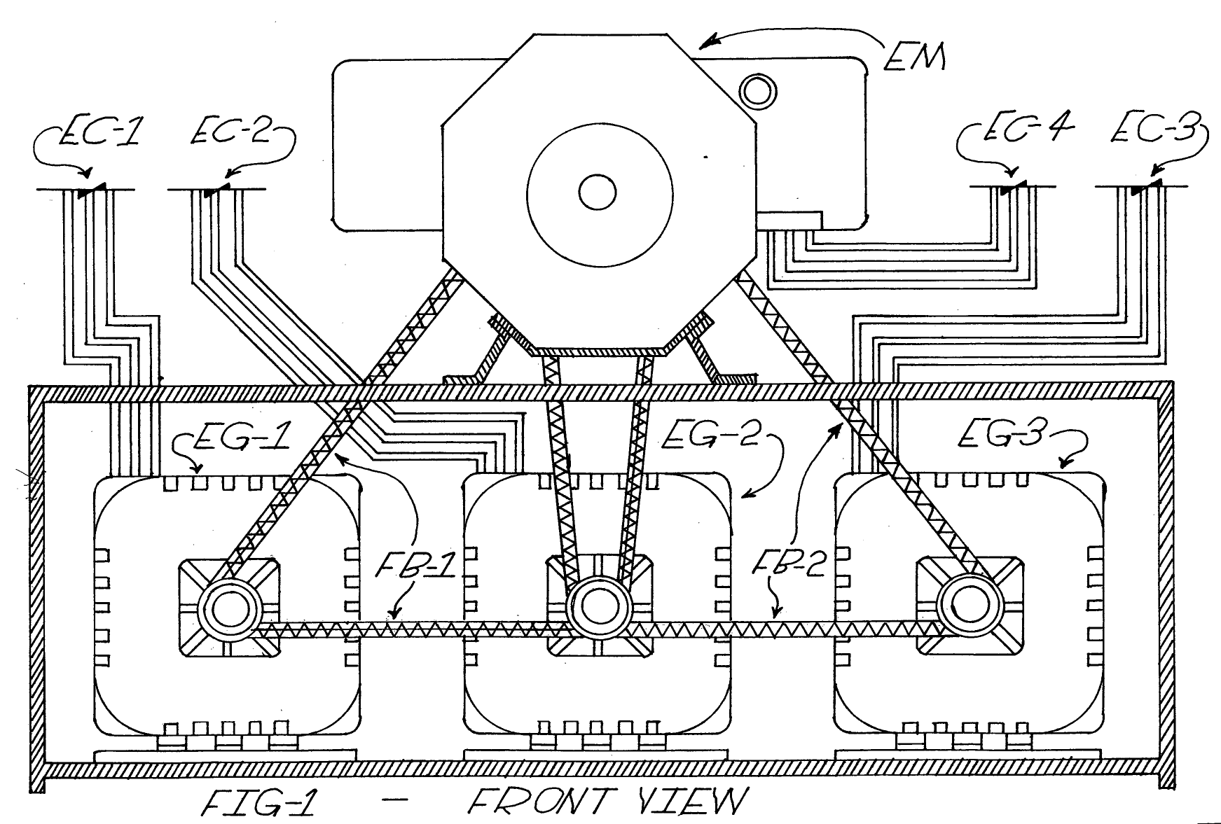

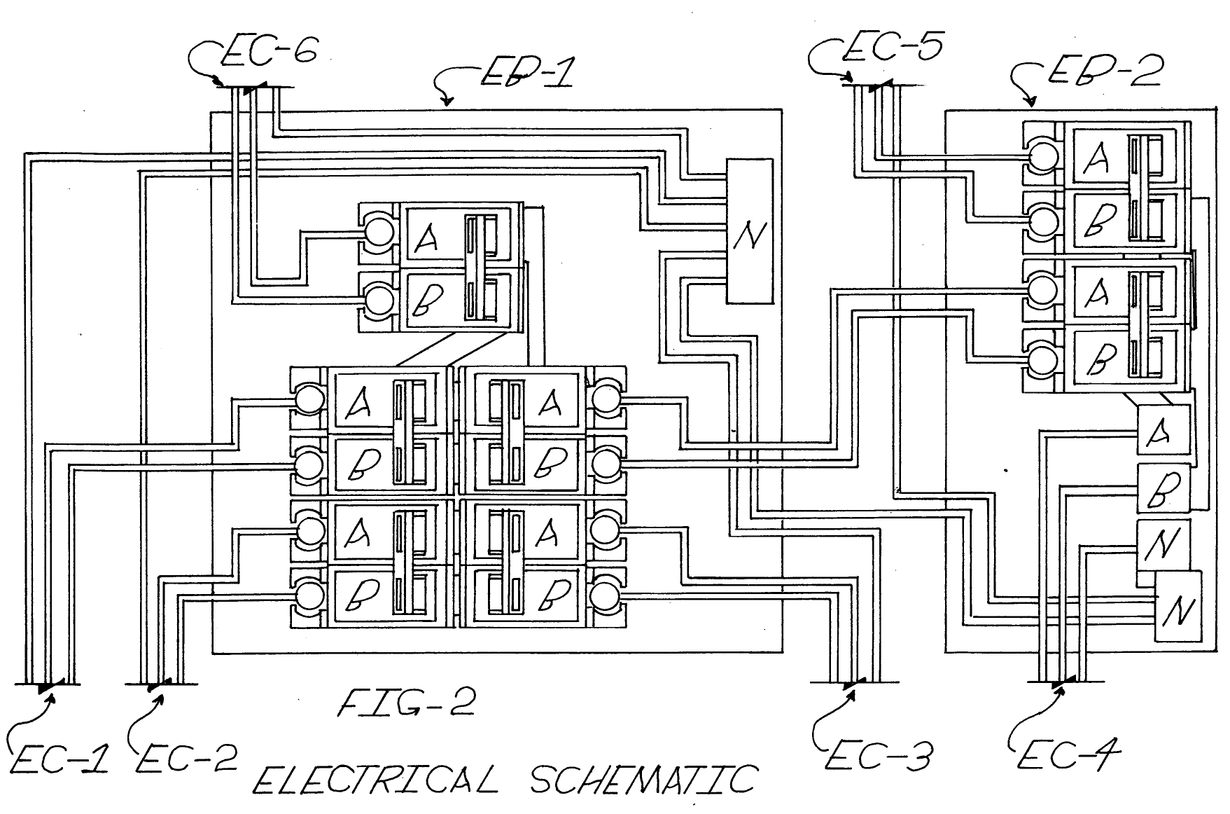

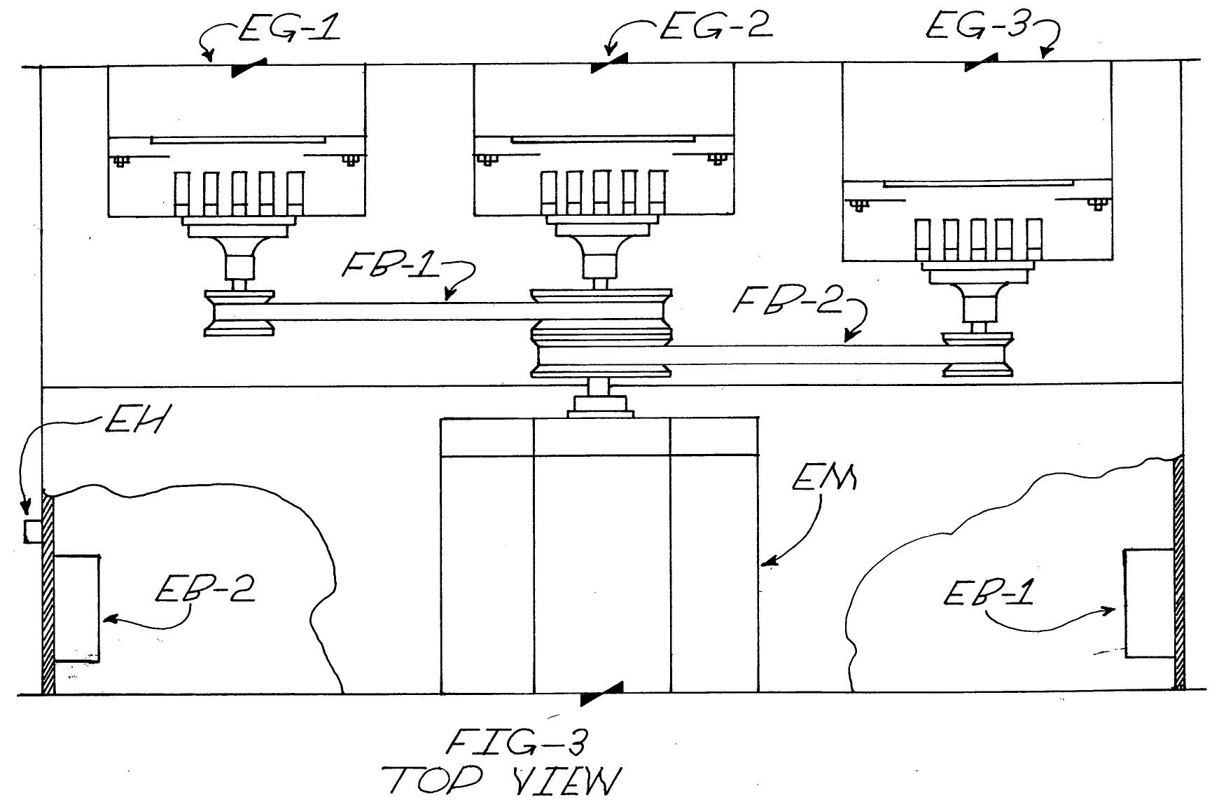

The year is 1985, and the world is looking for a new and reliable source of energy to produce electricity. I conceived an idea. after hooking up two power packs to my electric train layout, I wondered if I could do the same with two or more electrical generators. And if I could, I wondered if I could run them by hooking them to an electrical motor. I knew if the electrical motor would run the generators, I could run the same motor on the electricity produced by the generators.

I began drawing electrical circuit diagrams until I came up with the electrical loop. In 1999, after the purchase of my house, I began to buy the electrical supplies I needed to build the system. But, I could not find the electrical Motors, and Generators compatible for each other. Technology today is not built that way. In the first four months of 1999, I bought my three electrical generators, two 5,000 watts generators, and a 10,000 watts generator. I did some testing with the generators and found that I could run my house on the electricity produced by the generators without shorting them out. Although I could not find the electrical motor I needed for the system, it does not exist, I decided to take a different route. I bought an 80 gallon air compressor the run on an 6.5 horse power electrical motor that required 22.00 amps of electricity. Although the 5,000 watts electrical generator only produced 20.83 amps of electricity, it would still be enough electricity to run the electrical motor. After taking the electrical motor off the air compressor, and separating the electrical generator from the gas powered motor, I did some more testing and found the electrical motor could run the electrical generator, even though the electrical generator came off an 10 horse power gas motor. Then I added the electrical circuit loop to the electrical generator and the electrical motor, and thus, the JAFSTAR SYSTEM was born.

The JAFSTAR SYSTEM is a power plant that can supply any amount of electricity to any object, or any thing that uses electricity in any way for any reason. The JAFSTAR SYSTEM can produce enough electrical energy supply that can be used to power anything that uses electricity, such as; an electric car, bus, truck, or any other electrical auto vehicle. The JAFSTAR SYSTEM can be used to power trains, boats or ships, aircraft, and space stations and space shuttles. The JAFSTAR SYSTEM can also be used to power homes, factories, skyscrapers, and any other building or business possible. The JAFSTAR SYSTEM can even be used to power machinery, and other equipment.

The JAFSTAR SYSTEM is a group of one or more electrical generator(s), connected together, in a way, so it or they may be run by an electrical motor. The electrical motor is powered by the electricity produced by the electrical generator(s) it runs. The JAFSTAR SYSTEM can produce enough electricity to run itself and another load up to more than twice it's own.

Drawing A is a electrical drawing showing the two electrical panel boxes and how they are wired together to create an electrical loop in the JAFSTAR SYSTEM. It also shows how the circuit breakers are wired to keep the system from shortening out.

Drawing B is a front elevation of the JAFSTAR SYSTEM showing how the electrical motor is arranged in relations to the electrical generator(s). In this case, three electrical generators are tide to, and is powered by the electrical motor by two fan belts. It also shows the electrical circuits leading back to the electrical panel boxes in drawing A.

Drawing C is a drawing of three sectional drawings. Section 1 is a drawing showing the top view of the two fan belts and how they are wrapped around the pulleys of the motor and the three generators. Section 2 is a drawing showing how the two electrical panel boxes are mounted in the frame as positioned to the other components of the JAFSTAR SYSTEM. Section 3 is a drawing of the external electrical hook up, showing the electric circuit as it leads back to the electrical panel box in drawing A.

The Symbols From The Drawings Of The JAFSTAR SYSTEM:
E B Electrical Panel Box E C Electrical Circuit
E G Electrical Generator E M Electrical Motor
E H External Electrical Hook Up F B Fan Belt
A A side of electrical circuit and circuit breaker.
B B side of electrical circuit and circuit breaker.
N Neutral side of electrical circuit and neutral bar.

All circuit breakers are shown in the open (off) position. F B-1 wraps around the pulleys of E G-1, E G-2, and E M. F B-2 wraps around the pulleys of E G-2, E G-3, and E M. This unit may be built with one, two, three, or more generators. This unit may be built with fan belts and pulleys or gears.

When two or more electrical generators are used, only one generator should be able to produce enough electricity to run the electrical motor with no problems or strain. The other generator(s) should be able to produce enough electricity that is equal to or greater than the electricity produced by the generator that run the motor.
#1 Assemble together the frame.
#2 Attach the first shelf to one side of the frame. Attach the second shelf to the opposite side of the frame, five inches from, and seven inches above the first shelf. Attach the two end panels to each end of the frame.
#3 Attach one load center to the inside of each end panel. Attach one electrical outlet box to the outside of one of the end panels.
#4 Run three cables from one load center, under the two shelves, and to the other load center. Connect each end of one cable to a double circuit breaker rated at the same amps as the motor. Plug each circuit breaker into each load center so the cables are in the top position. This is the A SIDE of the circuit and the circuit breaker. Connect each end of the second cable into the bottom position of the two circuit breakers. This is the B SIDE of the circuit and the circuit breaker. Connect each end of the third cable into the neutral bar of each load center. This is the NEUTRAL SIDE of the circuit.
#5 Position the generators on the first shelf, in line with each other, so the pulleys extend center between the edges of the two shelves. The second generator and the motor has a double grove pulley. The pulley of the first generator should line up with the inside grove of the pulley of the second generator. The pulley of the third generator should line up forward the pulley of the first generator, and in line with the outside grove of the pulley of the second generator. Secure all generators to the shelf.
#6 Run three cables from the first generator to the closer load center. This load center is now the POWER BOX, (or EB-1), and the other load center is now the SWITCH BOX (or EB-2). Connect the end of the neutral cable to the neutral bar. Connect the ends of the other two cables to a double circuit breaker rated at the same amps as the generator. Plug the circuit breaker into the power box across from the other circuit breaker. The circuit breaker connected to the generator is circuit breaker #1, and the circuit breaker connected to the switch box is circuit breaker #4. Repeat step #6 for the other generators. Make sure all cables on the A SIDE of the circuits go to the same side of all the generators.
#7 Position the motor on the second shelf so the pulley will line up with the pulleys of the generators. Wrap one fanbelt around the pulleys of the motor, and generators No. 1, and No. 2. Wrap a second fanbelt around the pulleys of the motor, and generator No. 2, and No. 3. Secure the motor to the shelf so the tension of the fanbelts are not too tight. Run the three cables from the motor to the switch box. Connect the neutral cable to the neutral bar. Connect the ends of the other two cables to the box bus bars.
#8 Run three cables from the outlet box to the switch box. In the switch box, connect the end of one cable to the neutral bar. Connect the ends of the other two cables to a double circuit breaker rated at the same amps as the motor. Plug the circuit breaker into the switch box across from the other circuit breaker. In the outlet box, connect the ends of the three cables to an receptacle outlet rated at the same amps as the motor. Secure the receptacle outlet into the outlet box. In the switch box, the circuit breaker connected to the outlet box is circuit breaker #1, and the circuit breaker connected to the power box is circuit breaker #2. Secure the covers onto all boxes.
#1 Make sure all circuit breakers are in the off position, inside the house and on the unit.
#2 Hook up external power unit into external power hook up.
#3 Start up external power unit.
#4 Turn on circuit breaker #1 in switch box.
#5 Turn on circuit breaker #1 in power box.
#6 Turn on circuit breaker #4 in power box.
#7 Turn on circuit breaker #2, in switch box, turning off circuit breaker #1 in switch box.
#8 Turn on circuit breaker #2, then #3 in power box.
#9 Shut down the external power unit and disconnect from external power hook up.
#10 Turn on main power circuit breaker in the house.

Wait one minute between each step. Step #7 and Step #8 may be in switched order.

The JAFSTAR SYSTEM is an electrical power plant that runs on it's own power, (electricity that the system produce itself). It does not run on any fuel of any kind; air, water, solar energy, or gas, liquid, or solid chemicals. The system does not give off any exhaust. The system does not have to be recharged. The JAFSTAR SYSTEM will run as long as it is not shut down, interrupted by any electrical shorts, or anything that would interfere with the electrical circuit, or the flow of electricity in a current. The system will run as long as the parts does not wear down, or out, and it does not overheat, catch fire, or burn out. As with all things, the JAFSTAR SYSTEM is only as good as the parts used to build it.

1. I, James A. Fair, claim. the JAFSTAR SYSTEM is an electrical power plant (generator) that runs on it's own power, (electricity that the system produce itself), with out any help from any outside source or fuel.
